(19) United States
(12) Patent Application Publication
(10) Pub. No.: US 2016/0332095 A1
(43) Pub. Date: Nov. 17, 2016

(54) Filtration System with Anti Drain Valve and Drain X-Seal

(71) Applicant: Cummins Filtration IP, Inc., Columbus, IN (US)

(72) Inventors: Wassem Abdalla, Cookeville, TN (US); Stéphane Simon, Guengat (FR); Gandhali R. Deshpande, Satara (IN); Jayant Singh, Pune (IN)

(73) Assignee: Cummins Filtration IP, Inc., Columbus, IN (US)

(21) Appl. No.: 15/150,022

(22) Filed: May 9, 2016

Related U.S. Application Data
(60) Provisional application No. 62/159,532, filed on May 11, 2015.

(51) Int. Cl. B01D 27/08

(52) U.S. Cl. CPC B01D 27/08; B01D 2201/304

(57) ABSTRACT

Various embodiments disclosed herein relate to a filter element having a seal that functions as an anti-drain seal. The seal prevents fluid being filtered (e.g., fuel) from flowing back to a fluid storage tank (e.g., a fuel tank) through a drain in the filter housing when the filter element is in an installed position within the filter housing. The seal and the filter housing allow fluid to flow back to the fluid storage tank when the filter element is being removed from the filter housing (e.g., during a filter change service). The seal is removably coupled to the filter element such that the seal can be reused with replacement filter elements. The seal also functions as an engine integrity protection mechanism. Thus, the seal performs functions as a sealing device, draining device, and engine integrity protection feature.

### CROSS-REFERENCE TO RELATED APPLICATIONS

This application claims priority to U.S. Provisional Patent Application No. 62/159,532, entitled “Filtration System With Anti Drain Valve and Drain X-Seal,” filed on May 11, 2015, which is herein incorporated by reference in its entirety and for all purposes.

### TECHNICAL FIELD

The present application relates to filtration systems. More particularly, the present application relates to fluid filtration systems having a replaceable filter element.

### BACKGROUND

Fluid filtration systems are used to provide clean fluid to a device. For example, internal combustion engines may have multiple filtration systems to provide clean fuel, clean oil, and clean hydraulic fluid to the various components of the internal combustion engines. Each filtration system generally includes a filter element having a filter media that filters the fluid. Some filtration systems, such as fuel and oil filtration systems, often use replaceable filter elements that require periodic filter element replacement services to ensure proper filtration of the fluids.

In some filtration systems, the filter element can remain immersed in the fluid to be filtered even when not in use. For example, after operation of an internal combustion engine has ceased, residual fuel to be filtered by a fuel filter element may remain in the filter element housing. In such situations, the residual fuel may spill from the filtration system during removal of the housing (e.g., removal of a shell housing that contains the filter element) or removal of the filter element from the housing during a service operation to change the filter element.

### SUMMARY

One example embodiment relates to a filtration system. The filtration system comprises a shell housing including a drain. The filtration system further comprises a filter element housed within the shell housing. The filter element comprises filter media positioned between a first endplate and a second endplate. The filter element further comprises a primary seal member coupled to the second endplate. The primary seal member is configured to prevent fluid to be filtered from exiting the shell housing through the drain when the filter element is in an installed position within the shell housing and to permit residual fluid to exit the shell housing through the drain when the filter element is displaced from the installed position.

Another example embodiment relates to a filter element. The filter element comprises a first endplate, a second endplate, and filter media positioned between the first endplate and the second endplate. The filter element further comprises a primary seal member coupled to the second endplate. The primary seal member is configured to prevent fluid to be filtered from exiting a shell housing through a drain in the shell housing when the filter element is in an installed position within the shell housing and to permit residual fluid to exit the shell housing through the drain when the filter element is displaced from the installed position.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is an exploded view of a filter element according to an exemplary embodiment.

FIG. 2 is a cross-sectional view of the filter element of FIG. 1 shown in an installed (i.e., operational) position within a filtration system.

FIGS. 3 and 4 show close-up cross sectional views of the primary seal of the filter element of FIG. 1 interacting with a shell housing when the filter element is received in the installed position within the shell housing.

FIG. 5 is a cross-sectional view of the filter element of FIG. 1 while in the process of being removed from the installed position from a filtration system.

### DETAILED DESCRIPTION

Referring to the figures generally, various embodiments disclosed herein relate to a filter element having a seal that functions as an anti-drain seal. The seal prevents fluid being filtered (e.g., fuel) from flowing back to a fluid storage tank (e.g., a fuel tank) through a drain in the filter housing when the filter element is in an installed position within the filter housing. The seal and the filter housing allow fluid to flow back to the fluid storage tank when the filter element is being removed from the filter housing (e.g., during a filter change service). Non-compatible filter elements without the seal will permit fluid to return to the fluid tank when the non-compatible filter element is installed in the filtration system. Since the fuel returns to the tank when the engine is off, the lack of fuel will cause a hard engine start when the engine is being restarted. Accordingly, the seal also functions as an engine integrity protection mechanism. Thus, the single seal performs multiple functions (anti-drain back to tank functions, draining functions, and engine integrity protection functions), thereby reducing the cost over traditional filter elements that require three separate components for each of the functions.

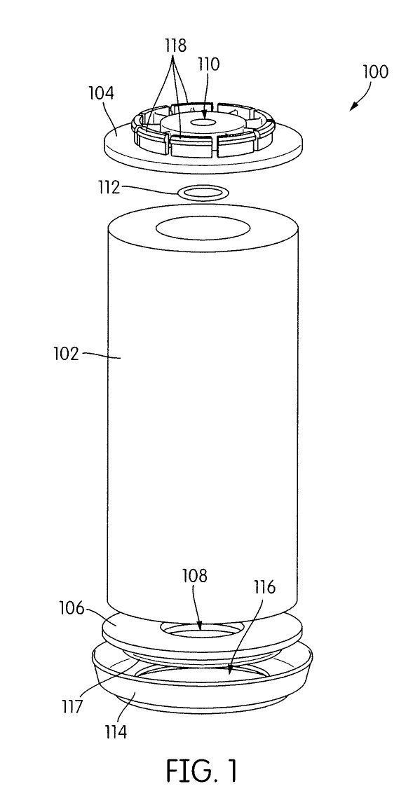

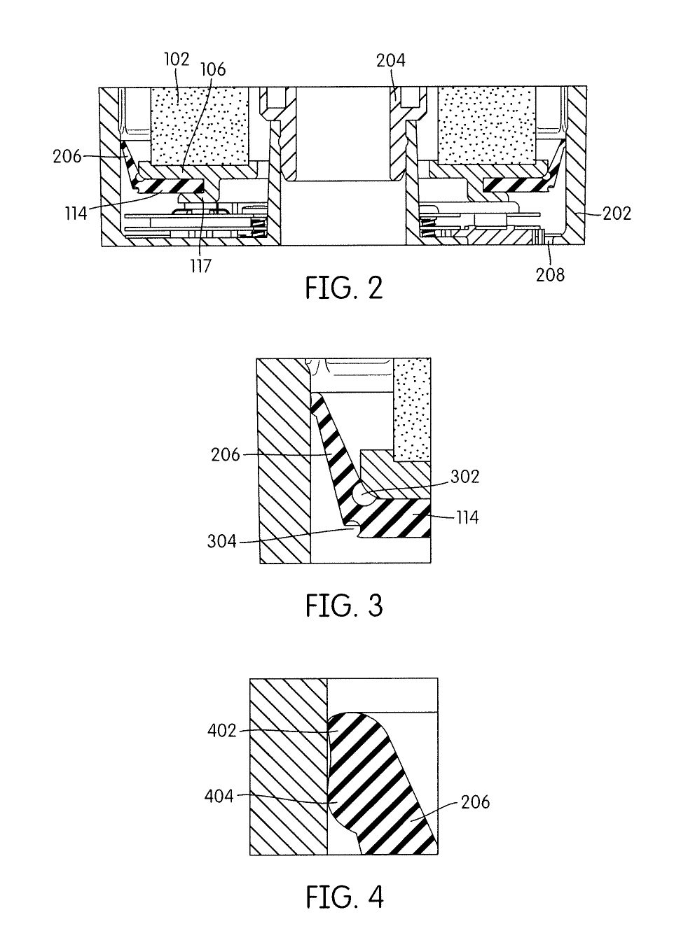

Referring to FIG. 1, an exploded view of a filter element 100 is shown according to an exemplary embodiment. The filter element 100 is a cylindrical filter element having cylindrical filter media 102. The filter media 102 includes an inner clean side and an outer dirty side. Accordingly, the filter element 100 is an outside-in flow filter element. In an alternative arrangement, the filter element 100 is an inside-out flow filter element having an inner dirty side and an outer clean side. Fluid to be filtered passes from the dirty side of the filter media 102 to the clean side of the filter media 102. The filter media 102 may include any of paper-based filter media, fiber-based filter media, foam-based filter media, or the like. The filter element 100 includes a first endcap 104 coupled to a first, top end of the filter media 102. The filter element 100 further includes a second endcap 106 coupled to a second, bottom end of the filter media 102. The second endcap 106 includes a second central opening 108. The second central opening 108 is sized and shaped to receive a component of a filtration system (e.g., a standpipe) when the filter element 100 is installed in an operating position within the filtration system (e.g., as shown in FIGS. 2 through 4). In some arrangements, the first endcap 104 includes a first central opening 110. The first central opening 110 is smaller than the second central opening 108. In some arrangements, the first central opening 110 routes fluid and air to a component (e.g., to an internal combustion engine). The filter element 100 further includes a batch 112. The batch 112 may be welded to the first endcap 104. In some arrangements, an inner seal is positioned between the first endcap 104 and the component (e.g., the standpipe) when the filter element 100 is installed in the filtration system. The inner seal seals the dirty side of the filter media 102 from the clean side of the filter media 102 when the filter element 100 is installed in a filtration system.

The filter element 100 includes a primary seal member 114. The primary seal member 114 is an anti-drain seal. The primary seal member 114 includes a central opening 116. The central opening 116 of the primary seal member 114 is aligned with the second central opening 108 thereby allowing the component (e.g., the standpipe) to be received through the central opening 116 of the primary seal member 114. The primary seal 114 and the second endcap 106 may be manufactured as a single, integrated piece (e.g., via an over molding or heat staking process). The primary seal member 114 is coupled to the second endcap 106. In some arrangements, the second endcap 106 includes a retainer member 117. In such arrangements, a snap-fit connection is formed between the retainer member 117 and central opening 116 of the primary seal member 114. The snap-fit connection removably secures the primary seal member 114 to the second endcap 106.

The first endcap 104 includes a plurality of retention tabs 118. The retention tabs 118 secure the filter element 100 to a filter mounting head of the filtration system when the filter element 100 is installed in the filtration system. For example, the retention tabs 118 may form a snap-fit connection with the filter mounting head of the filtration system as filter is installed in the filtration system. As described in further detail below, the retention tabs 118 removably secure the filter to the mounting head during removal of a shell housing of the filtration system, thereby permitting residual fluid in the housing to drain past the primary seal member 114 back into a fluid storage tank.

Referring to FIG. 2, a cross-sectional view of the filter element 100 installed in a filtration system is shown according to an exemplary embodiment. FIG. 2 shows the area of the filter element 100 near the second endcap 106. The filter element 100 is installed in an interior compartment of a shell housing 202 in an installed position (i.e., in an operational position that permits filtering of the fluid). A standpipe 204 of the filtration system extends through an interior of the filter element 100. In the installed or operational position, the filter element 100 is connected to the filter mounting head (e.g., as described above) and the shell housing 202 is also attached to the filter mounting head (e.g., via a threaded connection in arrangements where the shell housing 202 is a spin-on housing). An outer flange 206 of the primary seal member 114 presses against an inner surface of the shell housing 202, thereby creating a one-way valve allowing the fluid to enter the shell housing 202 and preventing the fluid from returning back to the fluid storage tank. Accordingly, the primary seal member 114 prevents fluid to be filtered from exiting through a drain 208 located in the shell housing 202 while the filter element 100 is received in the installed position within the shell housing 202. In such arrangements, the drain 208 connects the shell housing 202 to a fluid storage tank (e.g., the fuel tank of a vehicle powered by the internal combustion engine). Accordingly, the primary seal member 114 functions as an anti-drain back to the storage tank when the filter element 100 is installed in the shell housing 202 (e.g., between filter service operations).

FIGS. 3 and 4 show close-up cross sectional views of the primary seal member 114 interacting with the shell housing 202 when the filter element 100 is received in the installed position within the shell housing 202. As shown in FIG. 3, the primary seal includes flexing features 302 and 304. The flexing features 302 and 304 allow the outer flange 206 of the primary seal member 114 to flex with respect to the main body of the primary seal member 114. Accordingly, the flexing features 302 and 304 assist in creating the seal between the outer flange 206 and the shell housing 202. The flexing features 302 and 304 may be grooves or cuts in the primary seal member 114 positioned at the joint between the outer flange 206 and the main body of the primary seal member 114. The flexing features 302 and 304 also permit the primary seal member 114 to flex during full fluid flow, which reduces restriction and potential damage to the primary seal member 114 (e.g., reduces the risk of permanent deformation of the primary seal member 114). As shown in FIG. 4, the outer flange 206 includes a first sealing lobe 402 and a second sealing lobe 404. The inclusion of the two sealing lobes 402 and 404 creates a more robust seal between the primary seal member 114 and the inner surface of the shell housing 202.

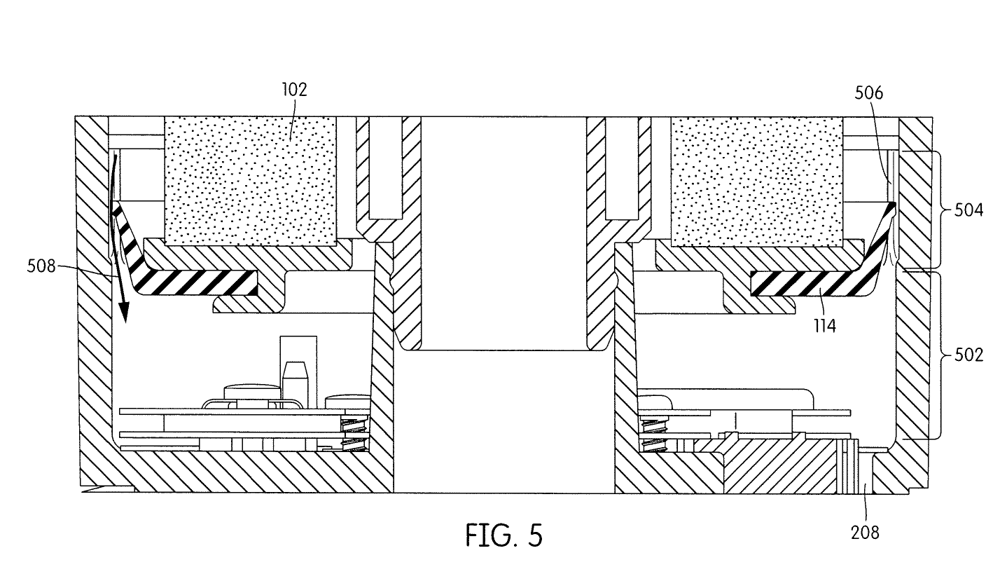

Referring to FIG. 5, a cross-sectional view of the filter element 100 in the process of being removed from the installed position from a filtration system is shown according to an exemplary embodiment. As the shell housing 202 is removed (e.g., spun off) from the filter mounting head, the filter element 100 remains attached to the filter mounting head through the retention tabs 118 (e.g., as discussed above with respect to FIG. 1). Accordingly the shell housing 202 slides with respect to the primary seal member 114. The shell housing 202 includes a variable inner diameter. When the filter element 100 is in the installed position, the sealing lobes 402 and 404 of the primary seal member 114 form a seal against first portion 502 of the shell housing 202. When the shell housing 202 is displaced from the filter element 100 during removal of the shell housing 202 (e.g., during a filter replacement service), the sealing lobes 402 and 404 slide to a second portion 504 of the shell housing that has a larger diameter than the first portion 502 prior to complete removal of the shell housing 202. The second portion 504 includes vertical ribs 506 that displace the sealing lobes 402 and 404 from the surface of the second portion 504 thereby eliminating the seal between the primary seal member 114 and the shell housing 202. The vertical ribs 506 prevent the sealing lobes 402 and 404 from being pressed against the surface of the second portion 504 by the weight of the residual fluid. Because there is no seal, fluid within the shell housing 202 can bypass the primary seal member 114 as shown by arrow 508 for draining out of the shell housing 202 through the drain 208.

Accordingly, when the filter element 100 is received in the installed position within the filtration system (i.e., within the shell housing 202 when both the shell housing 202 and the filter element 100 are secured to the filter mounting head), the primary seal member 114 forms a seal between the shell housing 202 and the sealing lobes 402 and 404. The seal prevents the fluid from exiting the shell housing 202 through the drain 208. During servicing of the filter element 100 (e.g., during filter element replacement) by a technician, the technician first removes the shell housing 202 from the filter mounting head. In doing so, the shell housing 202 is displaced relative to the filter element 100. In some arrangements, the filter element 100 will be removed from the top with a cover from the housing 202. In such arrangements, the cover will retain the filter element 100 through retention tabs 118. The primary seal member 114 slides along the inner surface of the shell housing 202. When the sealing lobes 402 and 404 reach the second portion 504 of the shell housing 202, the seal between the primary seal member 114 and the shell housing 202 is broken. The sealing lobes 402 and 404 are lifted from the surface of the second portion 504 by the vertical ribs 506, and the residual fluid within the shell housing 202 (i.e., between the filter media 102 and the shell housing 202) will drain past the primary seal member 114 and out of the drain 208. Accordingly, the filter element 100 can be serviced without spilling or wasting residual fluid in the shell housing 202.

Although the above-described filter element 100 is described in the context of a fuel filter, the same principles can be applied to other fluid filtration systems. For example, the same concepts may be applied to oil filters, hydraulic fluid filters, water filters, and the like.

It should be noted that any use of the term “exemplary” herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Additionally, features from particular embodiments may be combined with features from other embodiments as would be understood by one of ordinary skill in the art. Other substitutions, modifications, changes and omissions may also be made in the design, operating conditions and arrangement of the various exemplary embodiments without departing from the scope of the present invention.

What is claimed is:

1. A filtration system comprising:
a shell housing including a drain; and
a filter element housed within the shell housing, the filter element comprising filter media positioned between a first endplate and a second endplate, the filter element comprising a primary seal member coupled to the second endplate, the primary seal member configured to prevent fluid to be filtered from exiting the shell housing through the drain when the filter element is in an installed position within the shell housing and to permit residual fluid to exit the shell housing through the drain when the filter element is displaced from the installed position.

2. The filtration system of claim 1, wherein the primary seal member comprises a flexible flange having sealing lobes configured to seal against an inner surface of the shell housing when the filter element is in the installed position.

3. The filtration system of claim 1, wherein the primary seal member comprises at least one flexing feature configured to allow the primary seal member to flex.

4. The filtration system of claim 3, wherein the at least one flexing feature comprises a groove positioned between the flexible flange and a main body of the primary seal member.

5. The filtration system of claim 1, wherein the primary seal member is removably coupled to the second endplate.

6. The filtration system of claim 5, wherein the primary seal member is removably coupled to the second endplate via a snap-fit connection.

7. The filtration system of claim 5, wherein the primary seal member is attached to the second endplate via a mechanical or chemical lock.

8. The filtration system of claim 5, wherein the second endplate has a first central opening and the primary seal member has a second central opening, and wherein when the filter element is in the installed position, a standpipe is received through the second central opening.

9. The filtration system of claim 1, wherein the shell housing comprises a first portion having a first inner diameter and a second portion having a second inner diameter, the second inner diameter being larger than the first inner diameter.

10. The filtration system of claim 9, wherein the second portion comprises a vertical rib that prevents the primary seal member from forming a seal between the primary seal member and the shell housing.

11. The filtration system of claim 9, wherein when the filter element is in the installed position, the primary seal member form a seal against the first portion of the shell housing, and when the filter element is displaced from the installed position with respect to the shell housing, the primary seal member is prevented from forming a seal against the second portion of the shell housing by the vertical rib.

12. The filtration system of claim 1, further comprising a filter mounting head, and wherein the shell housing is removably secured to the filter mounting head.

13. The filtration system of claim 12, wherein the first endplate comprises a plurality of retention tabs structured to secure the filter element to the mounting head such that when the shell housing is removed from the filter mounting head, the filter element remains attached to the filter mounting head.

14. A filter element comprising:
a first endplate;
a second endplate;
filter media positioned between the first endplate and the second endplate;
a primary seal member coupled to the second endplate, the primary seal member configured to prevent fluid to be filtered from exiting a shell housing through a drain in the shell housing when the filter element is in an installed position within the shell housing and to permit residual fluid to exit the shell housing through the drain when the filter element is displaced from the installed position.

15. The filer element of claim 14, wherein the primary seal member comprises a flexible flange having sealing lobes configured to seal against an inner surface of the shell housing when the filter element is in the installed position.

16. The filter element of claim 14, wherein the primary seal member comprises at least one flexing feature configured to allow the primary seal member to flex.

17. The filter element of claim 16, wherein the at least one flexing feature comprises a groove positioned between the flexible flange and a main body of the primary seal member.

18. The filter element of claim 14, wherein the primary seal member is removably coupled to the second endplate.

19. The filter element of claim 18, wherein the primary seal member is removably coupled to the second endplate via a snap-fit connection, a mechanical lock, or a chemical lock.

20. The filter element of claim 14, wherein the first endplate comprises a plurality of retention tabs structured to secure the filter element to a mounting head of a filtration system.
